(19) United States
(12) Patent Application Publication
(10) Pub. No.: US 2019/0005540 A1
(43) Pub. Date: Jan. 3, 2019

(54) PURCHASE ANALYTICS DERIVED FROM A CONSUMER DECISION JOURNEY MODEL

(71) Applicant: MICROSOFT TECHNOLOGY LICENSING, LLC, REDMOND, WA (US)

(72) Inventors: Sundarrajan GANAPATHISUBRAMANIAN, BOTHELL, WA (US); Gunyoung HAN, BELLEVUE, WA (US); Supratim Roy CHAUDHURY, SAMMAMISH, WA (US); Karthikeyan ASOKKUMAR, BELLEVUE, WA (US); Apurv PANT, REDMOND, WA (US); Walter SUN, BELLEVUE, WA (US); Paul Joseph APODACA, MERCER ISLAND, WA (US); Hung-An CHANG, NEWCASTLE, WA (US); Mayank SHRIVASTAVA, KIRKLAND, WA (US)

(21) Appl. No.: 15/638,880

(22) Filed: Jun. 30, 2017

(51) Int. Cl. G06Q 30/02

(52) U.S. Cl. CPC G06Q 30/0255; G06Q 30/0224; G06Q 30/0204; G06Q 30/0201

(57) ABSTRACT

Systems, methods, computer storage media, and user interfaces are provided for providing analytics tools derived from a consumer decision journey model. Once the consumer decision journey for a particular good or service is constructed, a series of tools is provided to help a user understand the return on investment for providing different types of multimedia content at different stages in the consumer decision journey for a particular demographic. To do so, an interface is provided to the user that enables the user to select a desired tool and features of the tool the user wishes to exploit. Browser history from a plurality of consumers is transformed into a visual representation that provides insights into the types of multimedia content that can provide the greatest return on investment for a particular demographic at a particular state in the consumer decision journey for the selected category of goods or services.

### BACKGROUND OF THE INVENTION

In today's digital age, most high value purchase decisions are performed online. This is true whether the product is ultimately purchased online (e.g., making a hotel reservation) or at a physical location (e.g., buying a car). Consumer research prior to making purchase decisions is often lengthy and time consuming, and the decision making process is complex. However, despite growing trends towards personalization of the online experience, there is no solution that understands the overall consumer decision journey (i.e., the research and decision making process) for a given product or service. Consequently, information may not be organized appropriately for the specific needs of the users interested in the given product or service.

The consumer decision journey may be complicated because of the voluminous digital trail of information based on the activity of consumers of the given product or service. Thus, time and cost are significant obstacles to gathering user online behavior data, whether it is for product planning, creating user scenarios, or understanding consumer insights. Instead, a small size of focus group of data is typically relied on which does not represent implications for a larger scale of users. As a result, the mix of participants in the group of data may be biased and a complete understanding of consumer decision journeys is prohibitively complex.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, computer storage media, and user interfaces are provided for providing analytics tools derived from a consumer decision journey model. More particularly, once the consumer decision journey for a particular good or service is constructed, a series of tools is provided to help a user understand the return on investment for providing different types of multimedia content at different stages in the consumer decision journey for a particular demographic. To do so, an interface is provided to the user that enables the user to select a desired tool and features of the tool the user wishes to exploit. Options corresponding to a category of goods or services (e.g., a particular model, type, or feature of the goods or services) may be selected by the user to narrow the focus of the results provided by the desired tool. Browser history from a plurality of consumers is transformed into a visual representation that provides insights into the types of multimedia content that can provide the greatest return on investment for a particular demographic at a particular state in the consumer decision journey for the selected category of goods or services.

### BRIEF DESCRIPTION OF THE DRAWING

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 schematically shows a network diagram suitable for performing embodiments of the present invention;

FIGS. 3-14 depict illustrative screen displays, in accordance with exemplary embodiments of the present invention; and

FIG. 15 is a flow diagram showing an exemplary method for providing analytics tools derived from a consumer decision journey model, in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As described in the Background, in today's digital age, most high value purchase decisions are performed online. This is true whether the product is ultimately purchased online (e.g., making a hotel reservation) or at a physical location (e.g., buying a car). Consumer research prior to making purchase decisions is often lengthy and time consuming, and the decision making process is complex. However, despite growing trends towards personalization of the online experience, there is no solution that understands the overall consumer decision journey (i.e., the research and decision making process) for a given product or service. Consequently, information may not be organized appropriately for the specific needs of the users interested in the given product or service.

The consumer decision journey may be complicated because of the voluminous digital trail of information based on the activity of consumers of the given product or service. Thus, time and cost are significant obstacles to gathering user online behavior data, whether it is for product planning, creating user scenarios, or understanding consumer insights. Instead, a small size of focus group of data is typically relied on which does not represent implications for a larger scale of users. As a result, the mix of participants in the group of data may be biased and a complete understanding of consumer decision journeys is prohibitively complex.

Various aspects of the technology described herein are generally directed to systems, methods, and computer-readable storage media for providing analytics tools derived from a consumer decision journey model. More particularly, once the consumer decision journey for a particular good or service is constructed, a series of tools is provided to help a user understand the return on investment for providing different types of multimedia content at different stages in the consumer decision journey for a particular demographic. To do so, an interface is provided to the user that enables the user to select a desired tool and features of the tool the user wishes to exploit. Options corresponding to a category of goods or services (e.g., a particular model, type, or feature of the goods or services) may be selected by the user to narrow the focus of the results provided by the desired tool. Browser history from a plurality of consumers is transformed into a visual representation that provides insights into the types of multimedia content that can provide the greatest return on investment for a particular demographic at a particular state in the consumer decision journey for the selected category of goods or services.

In embodiments, an algorithmic solution (i.e., the consumer decision journey modeler) processes digital footprints of online activities (i.e., browser data) for a plurality of users over a long period of time and isolates all relevant digital traces regarding a specific purchase decision (i.e., for a particular good or service). For example, a buyer of an automobile may typically experience a different path to purchase than a buyer of running shoes. Various type of user actions are identified, such as search, category navigation, product page view, and the like. Additionally, relevant entities and information (e.g., product, make, model, travel dates, etc.) are also identified to digitally recreate and refresh the basic skeleton of a typical consumer decision journey model for the goods or services.

For a particular good or service, the model can be isolated so each step in the decision making process and how it evolves can be understood. The model can be rapidly updated in an ongoing basis as more browser data becomes available. As can be appreciated, this algorithmic solution can be applied to any number of goods or services, as each may have unique paths to purchase. A set of analytic tools can reconstruct the browser data to accommodate the purpose of the user (e.g., customize a time frame, size, or filters of the data) so the data can be quickly transformed for analysis and assimilation into a multimedia content delivery strategy.

The analytics tools derived from the consumer decision journey model provides aggregate browser logs for a plurality of consumers pivoted around a specific subject in a time series as well as additional information that considers consumer actions (e.g., goods or services searched, goods or services browsed, goods or services viewed, goods or services categories viewed, domain categories viewed, etc.). Also, using the analytics tools, a user can easily track a consumer decision journey for a single user by analyzing the web pages visited for possible insights and patterns. Although described with respect to browser logs, any application or web traffic data may be similarly incorporated into the consumer decision journey model for use by the analytics tools.

As a result, the consumer decision journey can be better understood for a particular product or service. The user is able to ascertain a better understanding of why, what, and when consumers search for a particular good or service. Equipped with this knowledge and data, multimedia content can be provided to consumers that offer the greatest return on investment for a particular demographic at a particular state in the consumer decision journey for the selected category of goods or services.

Accordingly, one embodiment of the present invention is directed to one or more computer-readable storage media comprising computer-executable instructions that, when executed by a computer, causes the computer to perform operations that provide analytics tools derived from a consumer decision journey model. The operations include providing an analytics interface to a user. The analytics interface includes one or more of: a strategic planning tool, a media buying tool, a creative strategy tool, and a trends and management tool. The operations also comprise, based on a selection of a feature for a particular analytics tool of the analytics interface, providing options to the user, the options corresponding to a category of goods or services. The operations further comprise, upon receiving a selection of the options from the user, transforming browser history received from a plurality of consumers into a visual representation corresponding to the selected feature for the particular analytics tool and the category of goods or services. The selected feature illustrates one or more of: audience segments by interest, audience segments by size, path to purchase, product and competitive trends, digital destination, traditional media consumption, conquest, conquest over time, conquest by geography, top attributes, sequencing, trends and engagement, and measurement.

Another embodiment of the present invention is directed to a method of providing analytics tools derived from a consumer decision journey model. The method includes providing an analytics interface to a user. The analytics interface includes one or more of: a strategic planning tool, a media buying tool, a creative strategy tool, and a trends and management tool. The method also includes, based on a selection of a feature for a particular analytics tool of the analytics interface, providing options to the user. The options correspond to a category of goods or services. The method further includes, upon receiving a selection of the options from the user, transforming browser history received from a plurality of consumers into a visual representation corresponding to the selected feature for the particular analytics tool and the category of goods or services. The selected feature illustrates one or more of: audience segments by interest, audience segments by size, path to purchase, product and competitive trends, digital destination, traditional media consumption, conquest, conquest over time, conquest by geography, top attributes, sequencing, trends and engagement, and measurement.

Yet another embodiment of the present invention includes a system for providing analytics tools derived from a consumer decision journey model. The system includes a processor and a computer storage medium storing computer-useable instructions that, when used by the processor, cause the processor to: provide an analytics interface to a user, the analytics interface including one or more of: a strategic planning tool, a media buying tool, a creative strategy tool, and a trends and management tool; based on a selection of a feature for a particular analytics tool of the analytics interface, provide options to the user, the options corresponding to a category of goods or services; and upon receiving a selection of the options from the user, transform browser history received from a plurality of consumers into a visual representation corresponding to the selected feature for the particular analytics tool and the category of goods or services, the selected feature illustrating one or more of: audience segments by interest, audience segments by size, path to purchase, product and competitive trends, digital destination, traditional media consumption, conquest, conquest over time, conquest by geography, top attributes, sequencing, trends and engagement, and measurement.

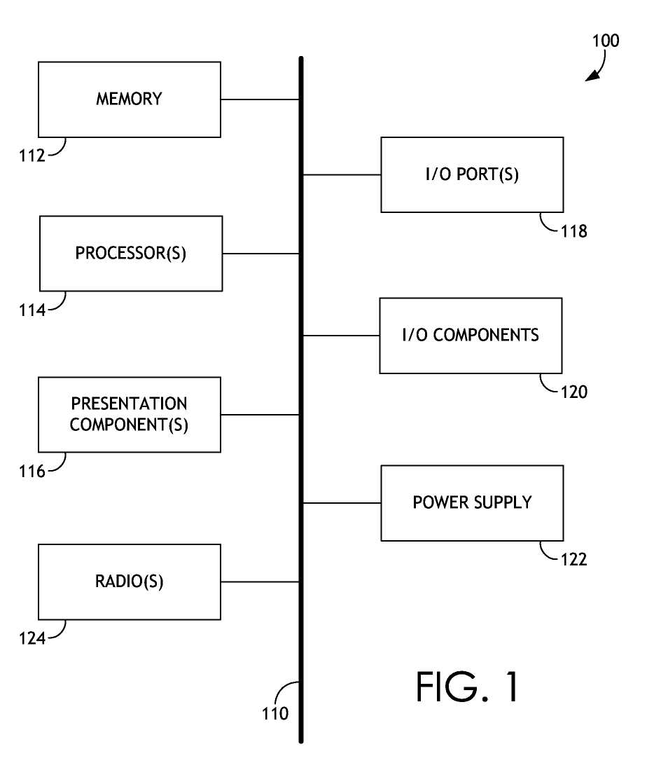

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one component nor any combination of components illustrated.

Embodiments of the invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures (i.e., motion or movements associated with a user's hand or hands or other parts of the user's body), voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like provided by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “consumer insights engine” is used herein, it will be recognized that this term may also encompass a server, a Web browser, a set of one or more processes distributed on one or more computers, one or more stand-alone storage devices, a set of one or more other computing or storage devices, any application, process, or device capable of providing analytics tools derived from a consumer decision journey model.

As previously mentioned, embodiments of the present invention are generally directed to systems, methods, and computer-readable storage media are provided for providing analytics tools derived from a consumer decision journey model. More particularly, once the consumer decision journey for a particular good or service is constructed, a series of tools is provided to help a user understand the return on investment for providing different types of multimedia content at different stages in the consumer decision journey for a particular demographic. To do so, an interface is provided to the user that enables the user to select a desired tool and features of the tool the user wishes to exploit. Options corresponding to a category of goods or services (e.g., a particular model, type, or feature of the goods or services) may be selected by the user to narrow the focus of the results provided by the desired tool. Browser history from a plurality of consumers is transformed into a visual representation that provides insights into the types of multimedia content that can provide the greatest return on investment for a particular demographic at a particular state in the consumer decision journey for the selected category of goods or services.

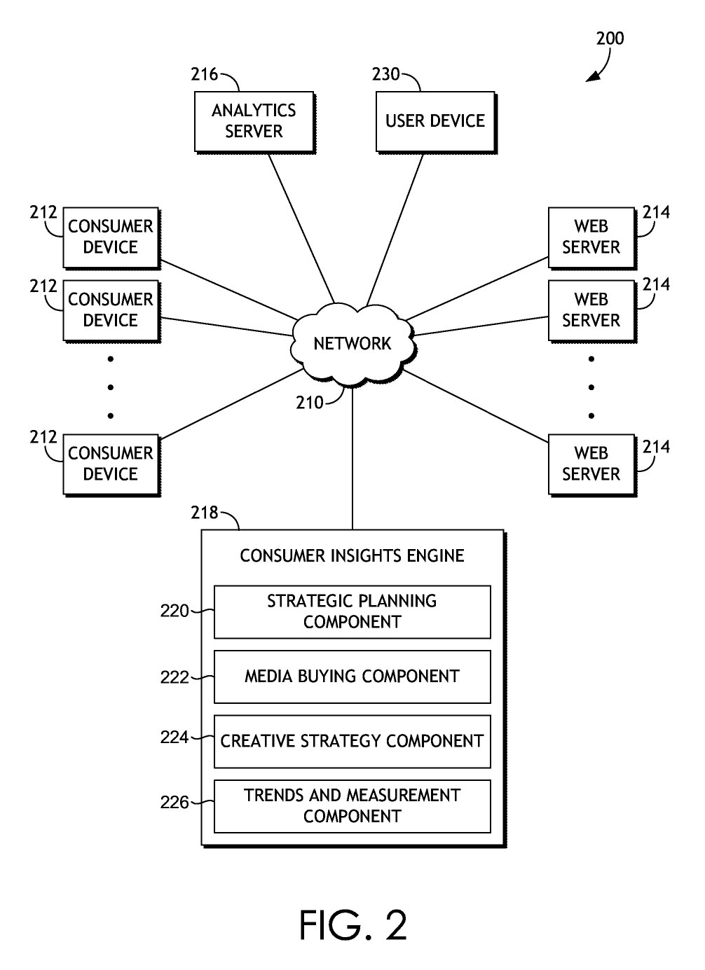

Referring now to FIG. 2, a block diagram is provided illustrating an exemplary computing system 200 in which embodiments of the present invention may be employed. Generally, the computing system 200 illustrates an environment that provides analytics tools derived from a consumer decision journey model. The computing system 200 generally includes consumer devices 212 (e.g., mobile device, television, watch, touch screen or tablet device, workstation, gaming system, and the like), web servers 214, analytics server 216, consumer insights engine 218, and user device 230 (e.g., mobile device, television, watch, touch screen or tablet device, workstation, gaming system, and the like), in communication with one another via a network 210. The network 210 may include, without limitation, one or more local area networks (LANs) and/or wide area networks (WANs). Such networking environments are commonplace in offices, enterprise-wide computer networks, intranets and the Internet. Accordingly, the network 210 is not further described herein.

It should be understood that any number of consumer devices 212, web servers 214, analytics servers 216, consumer insights engines 218, and/or user devices 230 may be employed in the computing system 200 within the scope of embodiments of the present invention. Each may comprise a single device/interface or multiple devices/interfaces cooperating in a distributed environment. For instance, the consumer insights engine 218 may comprise multiple devices and/or modules arranged in a distributed environment that collectively provide the functionality of the consumer insights engine 218 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via a consumer device 212, the analytics server 216, the consumer insights engine 218, a user device 230, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on and/or shared by any number of user devices, analytics servers, or consumer insights engines. By way of example only, the consumer insights engine 218 might be provided as a single computing device (as shown), a cluster of computing devices, or a computing device remote from one or more of the remaining components. Additionally, the consumer insights engine 218 may be provided by a single entity or multiple entities. For instance, a web server 214 (e.g., a search engine provider) could provide a portion of the analytics server 216 and/or the consumer insights engine 218 and a separate provider could provide the remaining portion of the analytics server 216 and/or the consumer insights engine 218. Any and all such variations are contemplated to be within the scope of embodiments herein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The consumer device 212 may include any type of computing device, such as the computing device 100 described with reference to FIG. 1, for example. Generally, the consumer device 212 includes a display and is capable of browsing web pages, such as web pages provided by web servers 214. Further, the consumer device 212 is able to act as a host for receiving multimedia content. The browsing process, among other things, is configured to render web pages and/or multimedia content in association with the display of the remote device 204. The remote device 204 is further configured to receive user input of requests for various web pages (including search engine home pages), receive user input search queries, receive user input to identify and refine intent and/or interact with a web page (generally via a user interface provided on the display and permitting alpha-numeric, voice, motion/gesture, and/or textual input into a designated input region) and to receive content for presentation on the display. It should be noted that the functionality described herein as being performed by the consumer device 212, web server 214, analytics server 216, and/or consumer insights engine 218 may be performed by any operating system, application, process, web browser, web browser chrome or via accessibility to an operating system, application, process, web browser, web browser chrome, or any device otherwise capable of acting as a host for web pages and/or multimedia content. It should further be noted that embodiments of the present invention are equally applicable to mobile computing devices and devices accepting touch, gesture, and/or voice input. Any and all such variations, and any combination thereof, are contemplated to be within the scope of embodiments of the present invention.

The analytics server 216 receives data from user devices 212 and/or web servers 214 regarding interactions, from a plurality of users via the user devices 212, with various web pages provided by web servers 214. In this way, the analytics server 216 processes digital footprints of online activities (i.e., browser data) for a plurality of users over a long period of time. All relevant digital traces regarding a specific purchase decision (i.e., for a particular good or service) can be isolated and utilized to create a consumer decision journey model for each good or service of interest.

In embodiments, the analytics server 216 receives additional information such as personal information and preferences. The additional information may be gathered via a personal data dashboard, browser history associated with the user, and personal cloud data. Initially, personal information may be provided based on content known by a search engine (e.g. BING). A consumer device 212 associated with the user may provide additional details to the analytics server 216. For example, the consumer device 212 may identify a geolocation associated with the consumer, indicate the consumer visited a particular location (e.g., a car dealership), or indicate the consumer diverted from a normal path to go to the particular location. Similarly, the consumer device 212 may include communications to or from the consumer indicating the consumer may be in a particular consumer decision journey state for a particular good or service.

Although not illustrated, the analytics server 216 may also have access to a database. It will be understood and appreciated by those of ordinary skill in the art that the information stored in association with the database may be configurable and may include any information relevant to browser interactions, a browser history associated with browser interactions, users, multimedia content, multimedia content campaigns, intents, intent signals, metadata and devices associated with the users. The content and volume of such information are not intended to limit the scope of embodiments of the present invention in any way. Further, the database may, in fact, be a plurality of storage devices, for instance a database cluster, portions of which may reside in association with consumer devices 212, web servers 214, analytics server 216, another external computing device (not shown), and/or any combination thereof. Further, the database may be separated into multiple storage devices or database clusters (e.g., one database storing user information and a separate database storing advertisement information).

The user device 230 may also include any type of computing device, such as the computing device 100 described with reference to FIG. 1, for example. Generally, the user device 230 includes a display and is capable of accessing the analytics tools provided by consumer insights engine 218, as described in more detail below. Further, the user device 230 is able to act as a host for receiving and displaying the output of the analytics tools provided by consumer insights engine 218.

The consumer insights engine 218 of FIG. 2 is configured to, among other things, provide analytics tools derived from a consumer decision journey model. As illustrated, in various embodiments, the consumer insights engine 218 includes a strategic planning component 220, a media buying component 222, a creative strategy component 224, and a trends and measurement component 226. Initially, the consumer insights engine 218 provides an analytics interface to a user. The analytics interface includes a strategic planning tool provided by the strategic planning component 220, a media buying tool provided by the media buying component 222, a creative strategy tool provided by the creative strategy component 225, and a trends and measurement tool provided by the trends and measurement component 226. In practice, the analytics interface initially provides options to the user for selecting a category of goods or services (e.g., automobile, computer, higher education, financial planning service, etc.)

As mentioned, the strategic planning component 220 of the consumer insights engine 218 is configured to provide the strategic planning tool. Generally, the strategic planning tool identifies who the consumers are and what the path to purchase looks like for a particular category of goods or services. In embodiments, features of the strategic planning tool comprise audience segments by interest, audience segments by size, path to purchase, product and competitive trends.

The audience segments by interest and audience segments by size features provide an affinity defined as a function of overlap between audience segments and the selection of options for the category of goods or services. As described herein, the audience segments are defined based on search and browsing behavior. Inputs for the features audience segments by interest and audience segments by size include selectable options relevant to the particular category of goods or services. In an automobile example, a user may select a make, model, or body type.

Continuing the automobile example, the audience segments by interest my show consumers with an affinity to a particular automobile model and make as defined by the selection of options. The audience segments may include any type of segment for which data is available (e.g., females over 24, females aged 50-64, sport utility vehicle researches, minivan and van researchers, new or expecting mothers, mothers, hybrid car researchers, healthy heart researchers, eco-friendly consumers, house managers, etc.). In embodiments, the strategic planning tool may additionally show consumers that do not have an affinity to the particular automobile model and make as define by the selection of options. The audience segments by interest and audience segments by size features may be utilized to compare segments with research-based approaches to traingulate the target consumer persona and/or map suggested segments to data management platform segments to enable targeting.

The path to purchase feature of the strategic planning tool generally identifies the browse journey and indicates what consumers for the selected category of goods or services actually search for as part of the path to purchase. For example, in the automobile example, the path to purchase feature might identify the average number of searches or page views for considered models in accordance with the options selected by the user, which may include competitor models. Additionally or alternatively, the path to purchase feature might identify the average number of searches or page views for considered makes in accordance with the options selected by the user, which may include competitor makes. Additionally or alternatively, the path to purchase feature might identify the average number of searches or page views for considered body styles in accordance with the options selected by the user, which may include competitor body styles. The path to purchase feature may be utilized to provide charts as part of a planning deck to highlight a competition and conquesting strategy and/or to recommend a cross-segment conquesting strategy.

The product and competition trends feature of the strategic planning tool generally identifies the trends of a product relative to competition. For example, the product and competition trends features may compare the average number of searches or page views of a particular product to the average number of searches or pages views for a competitor product. In another example, the product and competition trends feature may compare the audience segments by interest and audience segments by size between the particular product and a competitor product. As can be appreciated, the product and competition trends feature may compare any information available from the browser logs to highlight differences and similarities in the consumer decision journey for a particular product and a competitor product.

The media buying component 222 of the consumer insights engine 218 is configured to provide the media buying tool. Generally, the strategic planning tool identifies how to reach audiences, what digital destinations are being visited, what media is being consumed, and/or what competitors are being considered. In embodiments, features of the media buying tool comprise digital destination, traditional media consumption, conquest, conquest over time, and conquest by geography.

The digital destination feature generally identifies the top websites used for researching the particular category of goods or services and/or all top websites visited after searching for the particular category of goods or services (removes an average consumer behavior to understand website affinity). Inputs for the digital destination include selectable options relevant to the particular category of goods or services. In an automobile example, a user may select a make, model, or body type. The digital destination feature may be utilized to display targeting optimizations and to build a richer persona of a target audience.

The traditional media consumption feature identifies movies or songs searched by (not necessarily consumed by though) consumers corresponding to the particular category of goods or services (including any selected options) over time. This can be utilized to enable multimedia content targeting on television shows or music applications (e.g., SPOTIFY) as well as building a more robust persona of the target audience for the particular category of goods or services.

The conquest, conquest over time, and conquest by geography features identify the top explicit and the top implicit competitors for the particular category of goods or services (including any selected options). Explicit competitors are determined when a consumer searches for competitor goods or services corresponding to the selection of options for the category of goods or services in the same session while doing a direct comparison. On the other hand, implicit competitors are determined when a consumer searches for competitor goods or services corresponding to the selection of options for the category of goods or services in the same session without doing a direct comparison. The conquest, conquest over time, and conquest by geography features can be utilized to build and compare conquest lists, adjust budgets for each conquest model based on relative sizes, or identify cross segment conquest opportunity.

The creative strategy component 222 of the consumer insights engine 218 is configured to provide the creative strategy tool. Generally, the creative strategy tool identifies what message should be communicated, top attributes of the good or service consumers are searching, and/or sequencing (the order consumers search). In embodiments, features of the creative strategy tool comprise top attributes and sequencing.

The top attributes feature generally identifies how the good or service should be messaged. Inputs for the top attributes feature include selectable options relevant to the particular category of goods or services. In an automobile example, a user may select a make, model, or body type. The top attributes feature may provide attributes by search query types segmented by intents (based on the query tokens) or attributes by landing page types segmented by intents (based on the landing pages). The top attributes feature may be utilized to develop a messaging strategy that highlights the top searched attributes for the good or service and/or for search engine optimization/search engine marketing for campaigns based on user intents and landing pages.

The sequencing feature generally helps a user understand what consumers search for over the consumer decision journey. The sequencing feature identifies intent changes over a time period (e.g., per week). Continuing the automobile example, various intents may include discount, finance, insurance and price, comparison, dealership, miles per gallon, price, reviews, specifications, portals and top rank). For clarity, portals includes visits to third party websites and top rank includes superlatives (e.g., best rated, top ranked, etc.).

The trends and measurement component 226 of the consumer insights engine 218 is configured to provide the trends and measurement tool. In embodiments, features of the trends and measurement tool comprise trends and engagement and measurement.

The trends and engagement feature generally identifies search volumes for the particular good or service as well as geographical momentum for selected options of the particular good or service. Geographical momentum may identify the top 10 states (or geographical regions) with the most quarter-over-quarter growth or the top 10 states (or geographical regions) with the most quarter-over-quarter decline or least quarter-over-quarter growth. Inputs for the trends and engagement attributes feature include selectable options relevant to the particular category of goods or services. In an automobile example, a user may select a make, model, or body type. The trends and engagement feature may help a user measure the trend of various options pertaining to the particular good or service (e.g., model year) and compare against campaign objectives, compare model trends, or leverage historic trends and campaign budgets to predict campaign success.

The measurement feature may provide top search terms or awareness trends. For example the top search terms may provide the top good or service attributes (search tokens) by volume for the particular good or service over a selected time frame. The awareness trends may provide volumes of search tokens over a timeline of interest. The measurement feature may be utilized to measure the trend of top search terms and compare against campaign objectives or measure the trend of a particular option for the particular good or service and identify inflection points in changing the particular option.

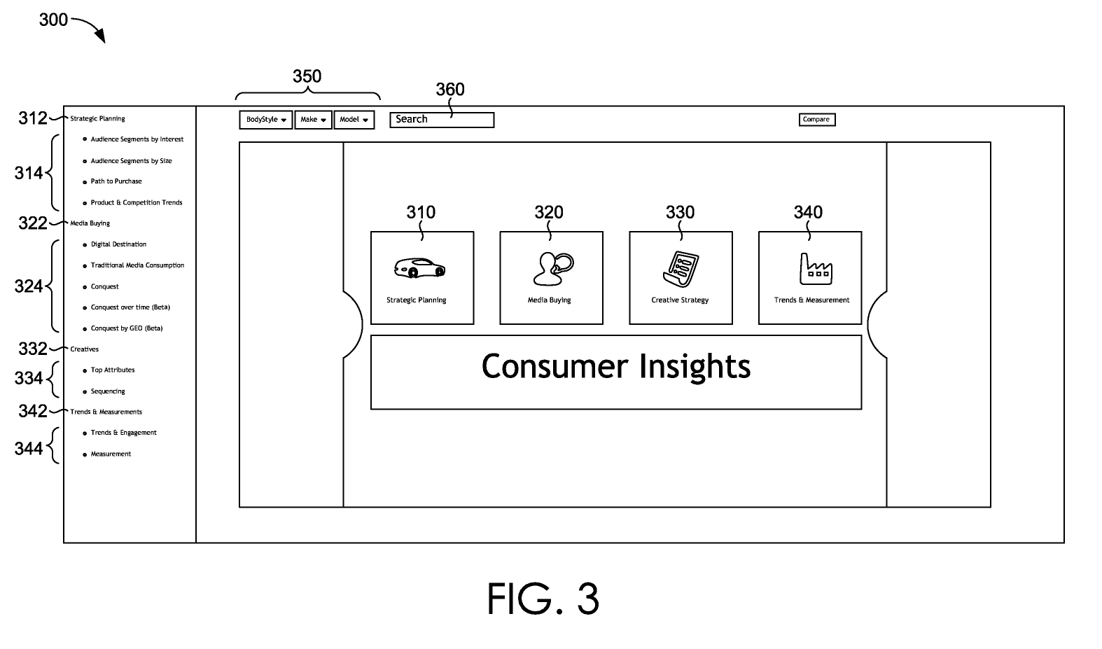

With reference to FIGS. 3-24, illustrative screen displays for analytics tools derived from a consumer decision journey model are provided. It is understood that each of the illustrative screen displays are connected logically, such that they comprise a user interface designed for providing various tools that illustrate features of consumer decision journeys for various goods or services. The screen displays may appear in any order and with any number of screen displays, without regard to whether the screen display is described or depicted herein.

Referring now to FIG. 3, an illustrative analytics interface 300 of an embodiment of the present invention is shown. The analytics interface 300 displays various analytics tools derived from a consumer decision journey model. The analytics tools include a strategic planning tool 310, a media buying tool 320, a creative strategy tool 330, and a trends and measurement tool 340. As illustrated, each of the analytics tools have various features that can be selected by the user. For example, strategic planning 312 includes features 314 (e.g., audience segments by interest, audience segments by size, path to purchase, and product and competition trends), media buying 322 includes features 324 (e.g., digital destination, traditional media consumption, conquest, conquest over time, and conquest by geography), creatives 332 includes features 334 (e.g., top attributes and sequencing), and trends and measurements 342 includes features 344 (e.g., trends and engagement and measurement).

The analytics interface 300 also enables a user to select options that can be selected from a dropdown menu 350 or a search bar 360. The options correspond to a particular category of goods or services. For example, if the user is interested in identifying insights for consumers of automobiles, the options may include bodystyle, make, and/or model. The options may vary according to the good or service being examined.

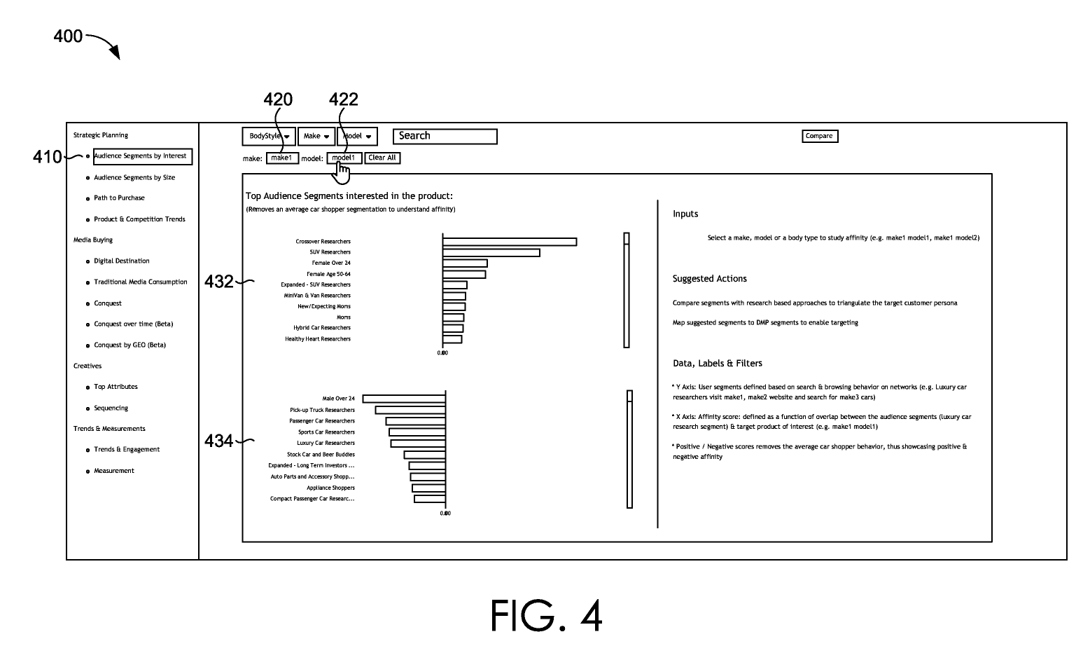

In FIG. 4, an illustrative analytics interface 400 of an embodiment of the present invention is shown. The user has selected the audience segments by interest feature 410 of the strategic planning tool. Additionally, options pertaining to the make and model (of an automobile) have also been selected by the user. As illustrated, the analytics interface 400 now displays two charts. The first chart 432 shows audience segments having a positive affinity to the particular make and model. In contrast, the second chart 434 shows audience segments having a negative affinity to the particular make and model. In each chart, the Y-axis corresponds to user segments defined based on search and browsing behavior on various networks (i.e., searching via a search engine or browsing a particular website). The X-axis represents the affinity score, which is defined as a function of overlap between the audience segments and the target good or service of interest. Average car shopper behavior has been removed from each chart so the positive and negative affinity can be showcased.

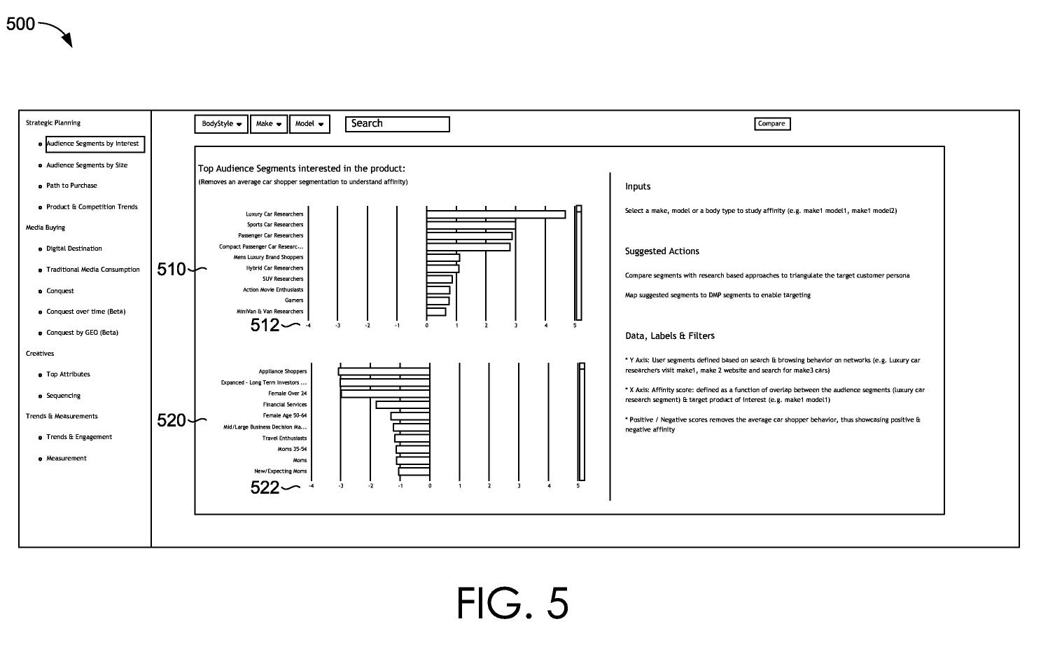

Turning now to FIG. 5, an illustrative analytics interface 500 of an embodiment of the present invention is shown. As illustrated, the analytics interface 500 is similar to the analytics interface 400 of FIG. 4 and also displays two charts. The first chart 510 shows audience segments having a positive affinity to the particular make and model. In contrast, the second chart 520 shows audience segments having a negative affinity to the particular make and model. In each chart, the Y-axis again corresponds to user segments defined based on search and browsing behavior on various networks (i.e., searching via a search engine or browsing a particular website). In the analytics interface 500, the X-axis 512, 522 now displays the affinity score.

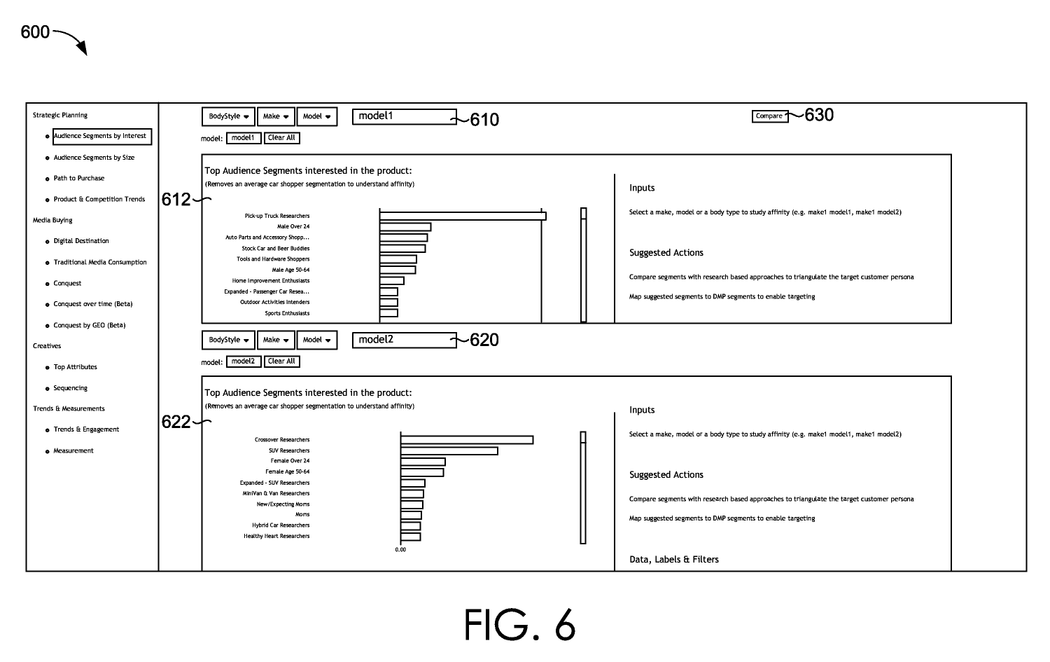

Referring now to FIG. 6, an illustrative analytics interface 600 of an embodiment of the present invention is shown. Again, the user has selected the audience segments by interest feature of the strategic planning tool. Additionally, options pertaining to the make and model (of an automobile) have also been searched 610, 622 by the user. As illustrated, the user has selected the compare option 630 and the analytics interface 600 displays two charts.

The first chart 612 shows audience segments having a positive affinity to a first option (i.e., modell) of the particular category of goods or services. In contrast, the second chart 622 shows audience segments having a positive affinity to the first option (i.e., modell) of the particular category of goods or services. In each chart, the Y-axis corresponds to user segments defined based on search and browsing behavior on various networks (i.e., searching via a search engine or browsing a particular website). The X-axis represents the affinity score, which is defined as a function of overlap between the audience segments and the target good or service of interest. Average consumer behavior has been removed from each chart so the positive and negative affinity can be showcased. Using each of the interfaces in FIGS. 4-6, based on the results, the user may be able to compare segments with research-based approaches to triangulate the target consumer persona and/or map suggested segments to data management platform segments to enable targeting.

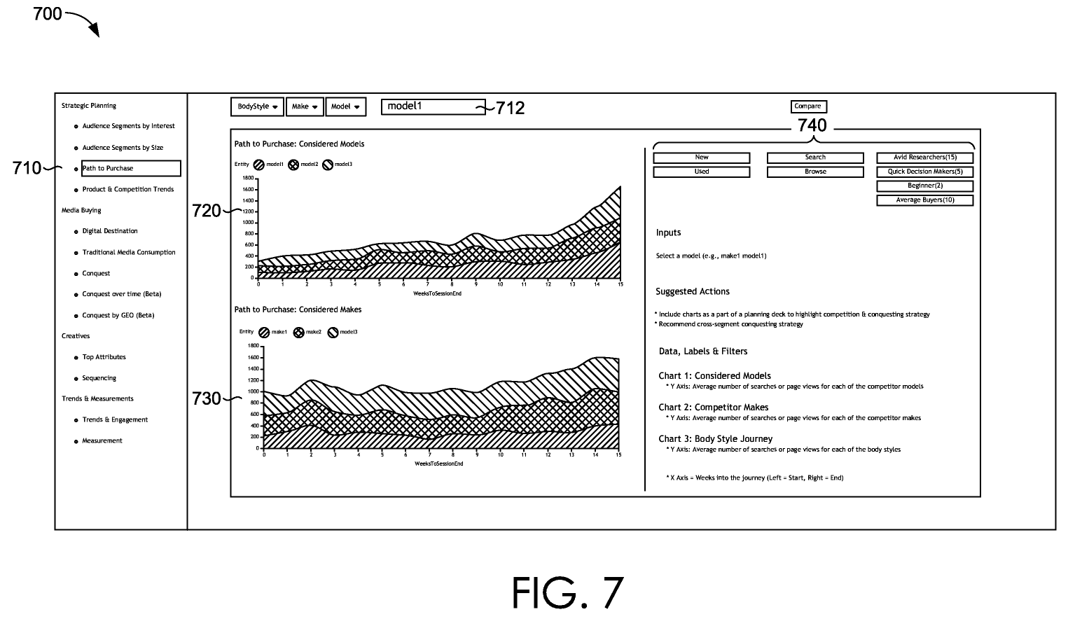

With reference now to FIG. 7, an illustrative analytics interface 700 of an embodiment of the present invention is shown. The user has selected the path to purchase feature 710 of the strategic planning tool. Additionally, options pertaining to particular good or service have been searched 712 by the user. As illustrated, the analytics interface 700 now displays two charts. The first chart 720 shows a path to purchase for considered models. The Y-axis corresponds to the average number of searches or page views for each of the competitor models. The second chart 730 shows a path to purchase for considered makes. In this chart, the Y-axis corresponds to the average number of searches or page views for each of the competitor makes.

Although not shown, a third chart could show a path to purchase for considered body styles (or for any other options relevant to the particular category of goods or services). In each chart, the X-axis corresponds to weeks into the consumer decision journey (i.e., the left side corresponds to the beginning and the right side corresponds to the end). The journey ends when a user potentially purchased the good or service (which may be indicated by, for example, three weeks of inactivity in the segment or a very high intensity in the last few weeks on the target good or service of choice.

Users may also select various filters 740 as an option. For example, with reference to the automobile example, a user may select to use various features of the analytics tools on new or used automobiles. The models are built using the types of websites visited during the consumer decision journey. The models may also consider the journey types. For example, a beginner may be consumers with a two-week journey. A quick decision maker may be consumers with two to five week journeys. Average buyers may be consumers with five to ten week journeys. Avid researchers may be consumers with ten to fifteen week journeys. Based on the results, the user may be able include charts as part of a planning deck to highlight competition and conquesting strategy and/or recommend cross-segment conquesting strategy.

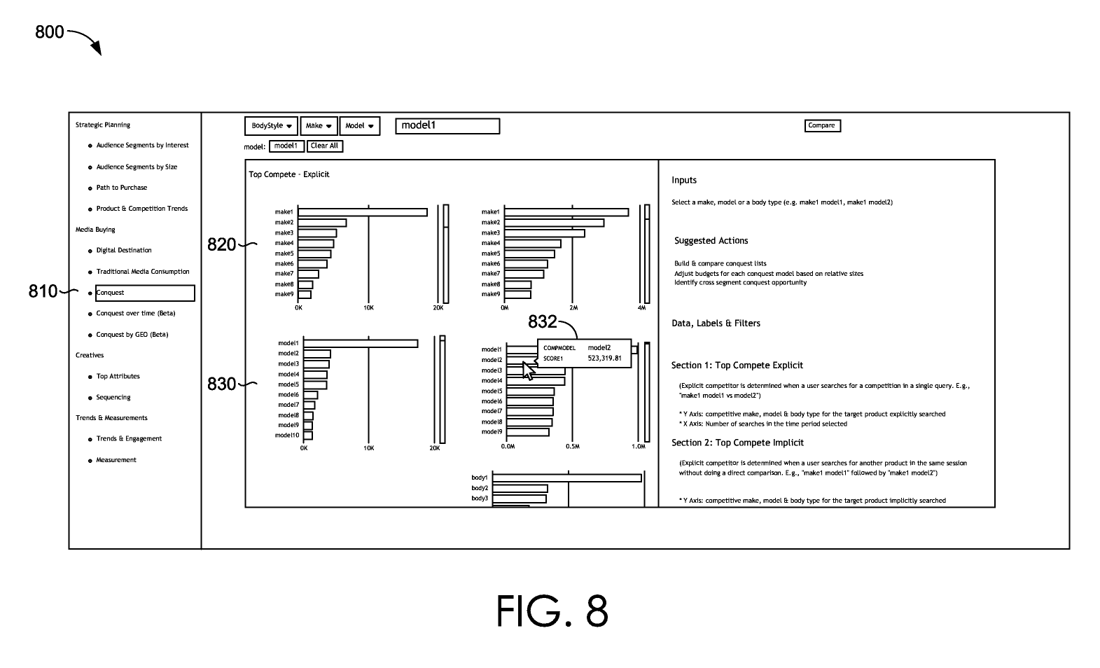

In FIG. 8, an illustrative analytics interface 800 of an embodiment of the present invention is shown. In the example shown, the user has selected the conquest feature 810 of the media buying tool. As illustrated, the analytics interface 800 now displays two charts. The first chart 820 shows the top explicit competitors. An explicit competitor is determined when a user searches for a competitor good or service in a single query while doing a direct comparison. The Y-axis corresponds to a competitive option (e.g., make, model, or body type) for the target good or service explicitly searched. The X-axis corresponds to the number of searches in the time period selected.

The second chart 830 shows the top implicit competitors. An implicit competitor is determined when a user searches for another good or service in the same session without doing a direct comparison. The Y-axis corresponds to a competitive option (e.g., make, model, or body type) for the target good or service implicitly searched. The X-axis corresponds to the number of searches in the time period selected. As illustrated, hovering over a particular item in the chart provides details 832 corresponding to the particular good or service having that option. Based on the results, the user may be able to build and compare conquest lists, adjust budgets for each conquest model based on relative sizes, and/or identify cross segment conquest opportunity.

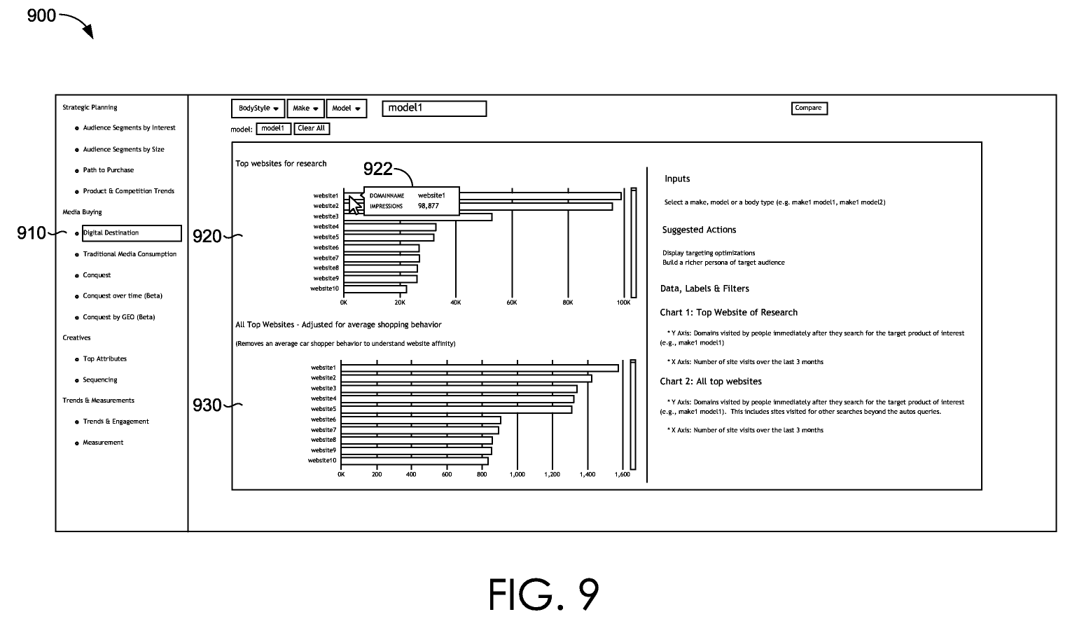

Referring now to FIG. 9, an illustrative analytics interface 900 of an embodiment of the present invention is shown. In the example shown, the user has selected the digital destination feature 910 of the media buying tool. As illustrated, the analytics interface 900 now displays two charts. The first chart 920 shows the top websites for research. The Y-axis corresponds to domains (i.e., websites) visited by consumers immediately after searching for the target good or service of interest. The X-axis corresponds to the number of visits over a period of time.

The second chart 930 shows all domains visited by consumers immediately after searching for the target good or service of interest (including websites visited for other searches beyond the search for the target good or service of interest). The X-axis corresponds to the number of visits over a period of time. As illustrated, hovering over a particular item in the chart provides details 922 corresponding to a particular domain including the number of visits to that domain. Average consumer behavior has been removed from chart 930 to better showcase website affinity. Based on the results, the user may be able to display targeting optimizations. Additionally or alternatively, the user may build a richer person of the target audience for the particular good or service.

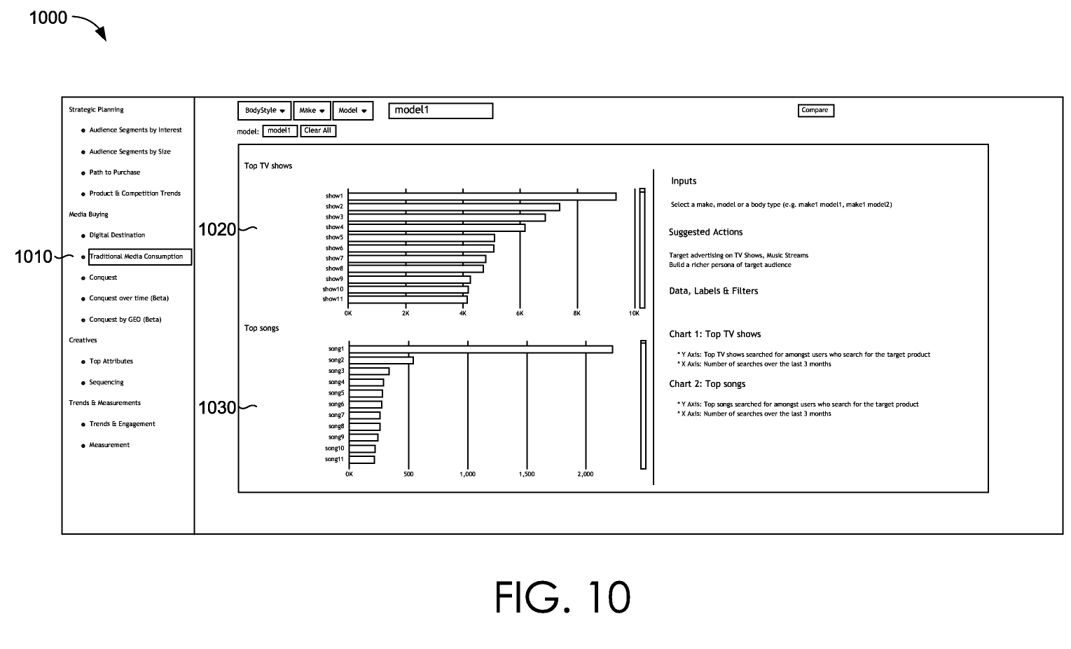

With reference now to FIG. 10, an illustrative analytics interface 1000 of an embodiment of the present invention is shown. In the example shown, the user has selected the traditional media consumption feature 1010 of the media buying tool. As illustrated, the analytics interface 1000 now displays two charts. The first chart 1020 shows the top television shows search for amongst consumers who search for the target good or service over a period of time. The second chart 1030 shows the top songs search for amongst users who search for the target good or service over a period of time. Based on the results, the user may be able to target multimedia content on certain television shows or music streams. Additionally or alternatively, the user may build a richer person of the target audience for the particular good or service.

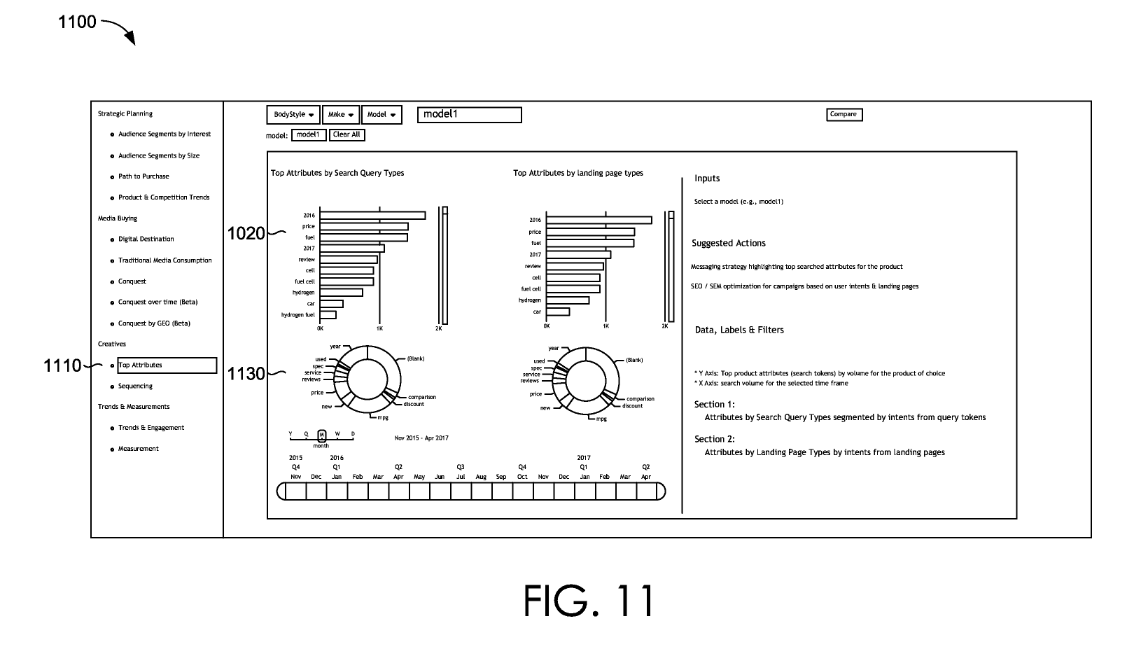

Referring now to FIG. 11, an illustrative analytics interface 1100 of an embodiment of the present invention is shown. In the example shown, the user has selected the top attributes feature 1110 of the creative strategy. As illustrated, the analytics interface 1100 now displays two charts. Each chart 1120, 1130 shows top product attributes (search tokens) by volume for the good or service of choice over a period of time. The first chart 1120 shows the attributes by search query types segmented by intents from the search tokens. In contrast, the second chart 1130 shows attributes by landing page types segmented by intents from the landing pages. Based on the results, the user may be able to develop a messaging strategy that highlights the top searched attributes for the good or service and/or for search engine optimization/search engine marketing for campaigns based on user intents and landing pages.

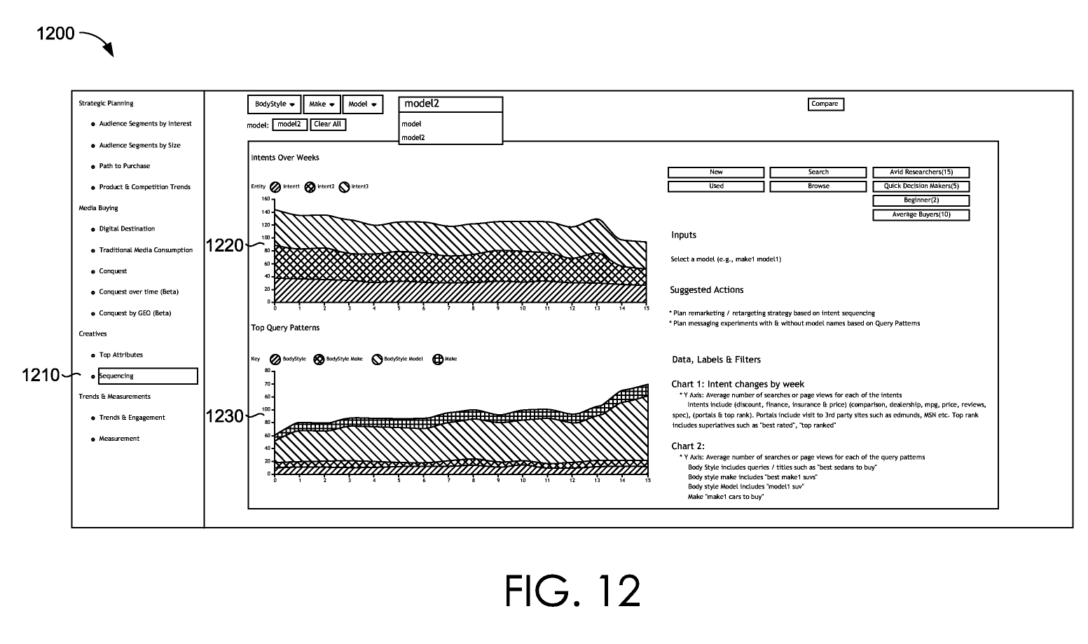

In FIG. 12, an illustrative analytics interface 1200 of an embodiment of the present invention is shown. In the example shown, the user has selected the sequencing feature 1210 of the creative strategy tool. As illustrated, the analytics interface 1200 now displays two charts. The first chart 1220 shows the intent changes over a period of time. The Y-axis corresponds to the average number of searches or page views for each of the intents. In embodiments, intents may include discount, finance, insurance and price, comparison, dealership, miles per gallon, price, reviews, specifications, portals and top rank). For clarity, portals includes visits to third party websites and top rank includes superlatives (e.g., best rated, top ranked, etc.).

The second chart 1230 shows the top query patterns over a period of time. The Y-axis corresponds to the average number of searches or page views for each of the query patterns. For example, the query patterns may include any patterns that appear in the queries corresponding to the options the user may select (i.e., in the automobile example, “best ‘body style’ to buy”, “best ‘make’ ‘body style’”, “‘model’ ‘body style’”, “‘make’ cars to buy”, etc.). Based on the results, the user may be able to plan remarketing/retargeting strategies based on intent sequencing and/or plan messaging experiments with and without specific options based on the query patterns.

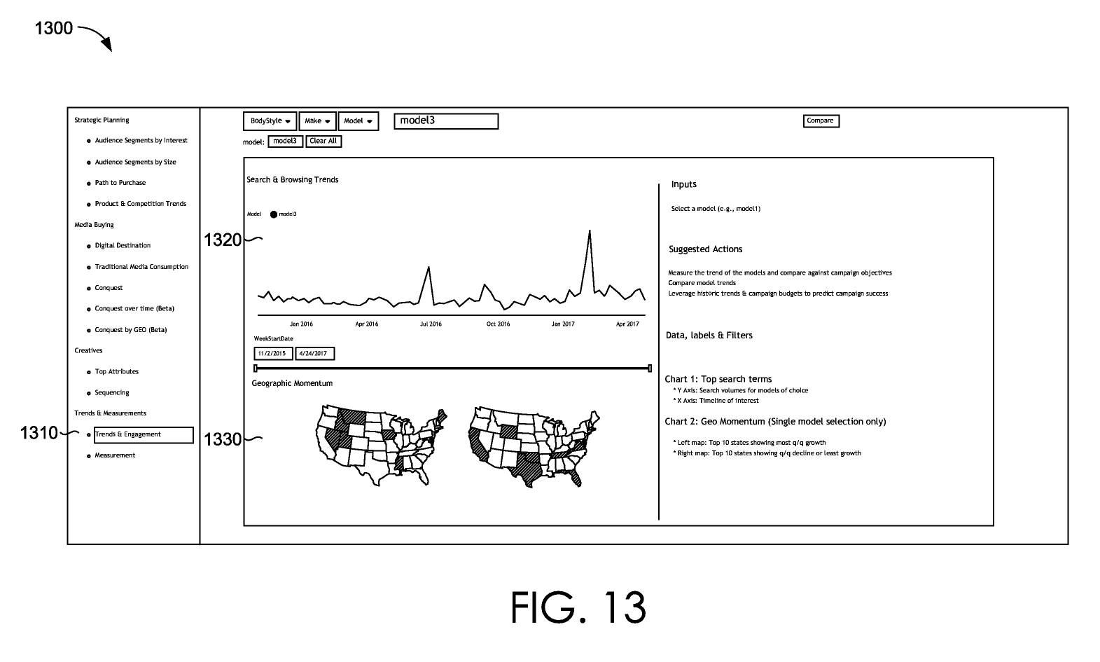

Turning now to FIG. 13, an illustrative analytics interface 1300 of an embodiment of the present invention is shown. In the example shown, the user has selected the trends and engagement feature 1310 of the trends and measurements tool. As illustrated, the analytics interface 1300 now displays two charts. The first chart 1320 shows the top search term over a period of time. The second chart 1330 shows the geographic momentum for a single target good or service over a period of time. Geographical momentum may identify the top 10 states (or geographical regions) with the most quarter-over-quarter growth or the top 10 states (or geographical regions) with the most quarter-over-quarter decline or least quarter-over-quarter growth. Based on the results, the user may be able to measure the trend of various options pertaining to the particular good or service (e.g., model year) and compare against campaign objectives, compare model trends, or leverage historic trends and campaign budgets to predict campaign success.

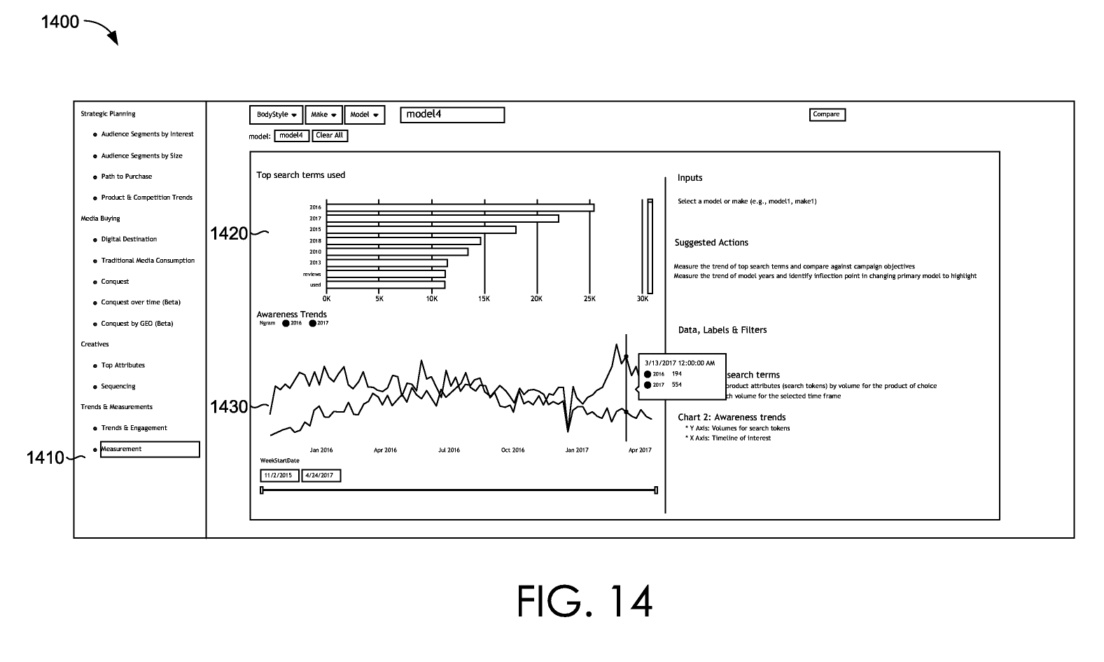

Referring now to FIG. 14, an illustrative analytics interface 1400 of an embodiment of the present invention is shown. In the example shown, the user has selected the measurement feature 1410 of the trends and measurements tool. As illustrated, the analytics interface 1400 now displays two charts. The first chart 1420 shows the top product attributes (search tokens) by volume for the target good or service over a period of time. The second chart 1430 shows the awareness trends (e.g., may be used to distinguish between model years) for the target good or service over a period of time. Based on the results, the user may be able measure the trend of top search terms and compare against campaign objectives and/or measure the trend of a particular option for the particular good or service and identify inflection points in changing the particular option.

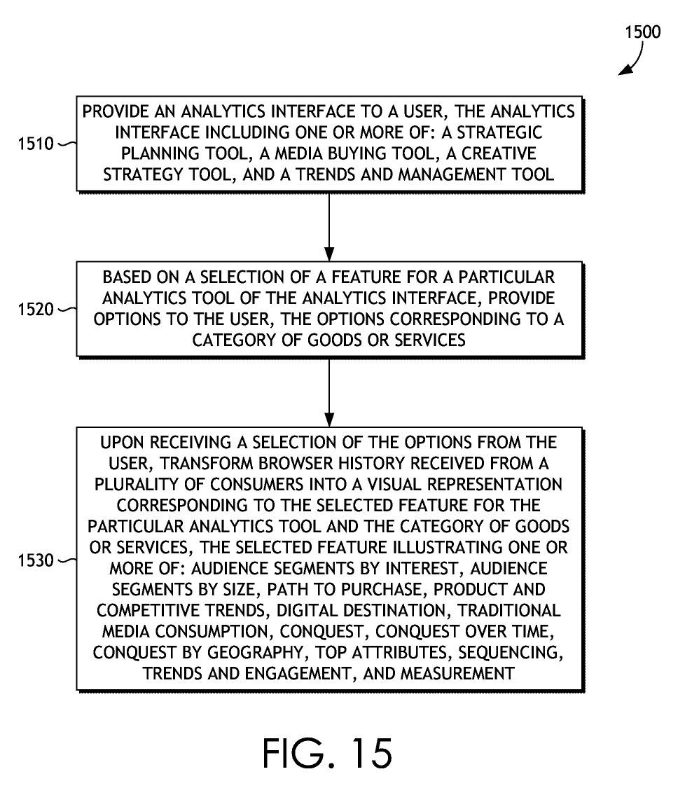

Referring now to FIG. 15, a flow diagram is provided that illustrates a method 1100 for providing analytics tools derived from a consumer decision journey model, in accordance with an embodiment of the present invention. As shown at block 1510, an analytics interface is provided to a user. The analytics interface includes one or more of: a strategic planning tool, a media buying tool, a creative strategy tool, and a trends and management tool.

At block 1520, based on a selection of a feature for a particular analytics tool of the analytics interface, options are provided to the user. The options corresponding to a category of goods or services.

At block 1530, upon receiving a selection of the options from the user, browser history received from a plurality of consumers is transformed into a visual representation corresponding to the selected feature for the particular analytics tool and the category of goods or services. The selected features illustrate one or more of: audience segments by interest, audience segments by size, path to purchase, product and competitive trends, digital destination, traditional media consumption, conquest, conquest over time, conquest by geography, top attributes, sequencing, trends and engagement, and measurement.

In embodiments, features of the strategic planning tool comprise audience segments by interest, audience segments by size, path to purchase, product and competitive trends. Audience segments by interest and the audience segments by size provide an affinity defined as a function of overlap between audience segments and the selection of options for the category of goods or services. The audience segments are defined based on search and browsing behavior. Path to purchase identifies an average number of searches or page views corresponding to the selection of options for the category of goods or services over time.

In embodiments, features of the creative strategy tool comprise digital destination, traditional media consumption, conquest, conquest over time, or conquest by geography. Digital destination identifies domains visited by the consumers immediately after a search corresponding to the selection of options for the category of goods or services. Traditional media consumption identifies movies or songs searched by the consumers corresponding to the selection of options for the category of goods or services over time. Conquest identifies explicit competitors, (determined when a consumer searches for competitor goods or services corresponding to the selection of options for the category of goods or services in a same session while doing a direct comparison) or implicit competitors (determined when a consumer searches for competitor goods or services corresponding to the selection of options for the category of goods or services in the same session without doing a direct comparison).

In embodiments, features of the media buying tool comprises top attributes and sequencing. Top attributes identify attributes searched for by consumers corresponding to the selection of options for the category of goods or services. Sequencing may identify an average number of searches or page views per intent over time corresponding to the selection of options for the category of goods or services. Intent may comprise one or more of discount, finance, insurance, price, comparison, dealership, miles per gallon, price, reviews, specification, visits to third party sites, or superlatives. Sequencing may identify an average number of searches or pages views for each of query pattern of the browser history corresponding to the selection of options for the category of goods or services.

In embodiments, features of the trends and management tool comprise trends and engagement and measurement. Trends and engagement may identify search volumes corresponding to the selection of options for the category of goods or services. Additionally or alternatively, trends and engagement may identify a geographical momentum of searches corresponding to the selection of options for the category of goods or services. Measurements may identify the top search tokens by volume for a selected time corresponding to the selection of options for the category of goods or services. Additionally or alternatively, measurements may identify an inflection point for a particular option of the selection of options for the category of goods or services.

As can be understood, embodiments of the present invention provide systems, methods, and computer-readable storage media for, among other things, providing analytics tools derived from a consumer decision journey model. The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in method 1500 of FIG. 15 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. A computer-readable storage media comprising computer-executable instructions that, when executed by a computer, causes the computer to perform operations that provide analytics tools derived from a consumer decision journey model, the operations comprising:
providing an analytics interface to a user, the analytics interface including one or more of: a strategic planning tool, a media buying tool, a creative strategy tool, and a trends and management tool;
based on a selection of a feature for a particular analytics tool of the analytics interface, providing options to the user, the options corresponding to a category of goods or services; and
upon receiving a selection of the options from the user, transforming browser history received from a plurality of consumers into a visual representation corresponding to the selected feature for the particular analytics tool and the category of goods or services, the selected feature illustrating one or more of: audience segments by interest, audience segments by size, path to purchase, product and competitive trends, digital destination, traditional media consumption, conquest, conquest over time, conquest by geography, top attributes, sequencing, trends and engagement, and measurement.

2. The media of claim 1, wherein the features of the strategic planning tool comprises audience segments by interest, audience segments by size, path to purchase, product and competitive trends.

3. The media of claim 2, wherein the audience segments by interest and the audience segments by size provide an affinity defined as a function of overlap between audience segments and the selection of options for the category of goods or services, the audience segments defined based on search and browsing behavior.

4. The media of claim 2, wherein the path to purchase identifies an average number of searches or page views corresponding to the selection of options for the category of goods or services over time.

5. The media of claim 1, wherein the features of the media buying tool comprises digital destination, traditional media consumption, conquest, conquest over time, conquest by geography.

6. The media of claim 5, wherein the digital destination identifies domains visited by the consumers immediately after a search corresponding to the selection of options for the category of goods or services.

7. The media of claim 5, wherein traditional media consumption identifies movies or songs searched by the consumers corresponding to the selection of options for the category of goods or services over time.

8. The media of claim 5, wherein conquest identifies explicit competitors, explicit competitors being determined when a consumer searches for competitor goods or services corresponding to the selection of options for the category of goods or services in a same session while doing a direct comparison, or implicit competitors, implicit competitors being determined when a consumer searches for competitor goods or services corresponding to the selection of options for the category of goods or services in the same session without doing a direct comparison.

9. The media of claim 1, wherein the features of the creative strategy tool comprises top attributes and sequencing.

10. The media of claim 9, wherein the top attributes identify attributes searched for by consumers corresponding to the selection of options for the category of goods or services.

11. The media of claim 9, wherein the sequencing identifies an average number of searches or page views per intent over time corresponding to the selection of options for the category of goods or services.

12. The media of claim 11, wherein intent comprises one or more of discount, finance, insurance, price, comparison, dealership, miles per gallon, price, reviews, specification, visits to third party sites, or superlatives.

13. The media of claim 9, wherein the sequencing identifies an average number of searches or pages views for each of query pattern of the browser history corresponding to the selection of options for the category of goods or services.

14. The media of claim 1, wherein the features of the trends and management tool comprises trends and engagement and measurement.

15. The media of claim 14, wherein the trends and engagement identifies search volumes corresponding to the selection of options for the category of goods or services.

16. The media of claim 14, wherein the trends and engagement identifies a geographical momentum of searches corresponding to the selection of options for the category of goods or services.

17. The media of claim 14, wherein the measurements identifies the top search tokens by volume for a selected time corresponding to the selection of options for the category of goods or services.

18. The media of claim 14, wherein the measurements identifies an inflection point for a particular option of the selection of options for the category of goods or services.

19. A method of providing analytics tools derived from a consumer decision journey model, the method comprising:
providing an analytics interface to a user, the analytics interface including one or more of: a strategic planning tool, a media buying tool, a creative strategy tool, and a trends and management tool;
based on a selection of a feature for a particular analytics tool of the analytics interface, providing options to the user, the options corresponding to a category of goods or services; and
upon receiving a selection of the options from the user, transforming browser history received from a plurality of consumers into a visual representation corresponding to the selected feature for the particular analytics tool and the category of goods or services, the selected feature illustrating one or more of: audience segments by interest, audience segments by size, path to purchase, product and competitive trends, digital destination, traditional media consumption, conquest, conquest over time, conquest by geography, top attributes, sequencing, trends and engagement, and measurement.

20. A system for providing analytics tools derived from a consumer decision journey model, the system comprising:
a processor;
and a computer storage medium storing computer-useable instructions that, when used by the processor, cause the processor to:
provide an analytics interface to a user, the analytics interface including one or more of: a strategic planning tool, a media buying tool, a creative strategy tool, and a trends and management tool;
based on a selection of a feature for a particular analytics tool of the analytics interface, provide options to the user, the options corresponding to a category of goods or services; and
upon receiving a selection of the options from the user, transform browser history received from a plurality of consumers into a visual representation corresponding to the selected feature for the particular analytics tool and the category of goods or services, the selected feature illustrating one or more of: audience segments by interest, audience segments by size, path to purchase, product and competitive trends, digital destination, traditional media consumption, conquest, conquest over time, conquest by geography, top attributes, sequencing, trends and engagement, and measurement.
